(19) United States
(12) Patent Application Publication
(10) Pub. No.: US 2026/0213415 A1
(43) Pub. Date: Jul. 23, 2026

(54) ANTENNA STRUCTURE AND ELECTRONIC DEVICE

(71) Applicant: HONOR DEVICE CO., LTD., Shenzhen (CN)

(72) Inventors: Aofang Zhang, Shenzhen (CN); Shaojie Chu, Shenzhen (CN); Kunpeng Wei, Shenzhen (CN); Dehua Meng, Shenzhen (CN)

(21) Appl. No.: 19/143,108

(22) PCT Filed: Aug. 14, 2023
(86) PCT No.: PCT/CN2023/112861

§ 371 Date: Jun. 25, 2025

(30) Foreign Application Priority Data
Dec. 26, 2022 (CN) 202211674628.0

(51) Int. Cl. H01Q 9/04; H01Q 1/24; H01Q 5/20; H01Q 5/357; H01Q 5/50; H01Q 7/00

(52) U.S. Cl. CPC H01Q 9/0421; H01Q 5/20; H01Q 5/357; H01Q 5/50; H01Q 1/242; H01Q 7/00; H01Q 9/0464

(57) ABSTRACT

This application relates to the field of terminal technologies and the field of antenna technologies, and provides an antenna structure and an electronic device. The antenna structure includes an antenna body and a dielectric layer. The antenna body is attached to the dielectric layer. The antenna body is shaped like a ring. The antenna body includes a feed point, a gap, a first ground point, and a second ground point. The gap is located between the feed point and the second ground point, and the gap extends toward the first ground point. Through the solution, in a scenario where a border frame area of the electronic device is covered with metal, an antenna that supports a plurality of bands may still be designed through a camera decoration member area of the electronic device, which has relatively high efficiency and broadband radiation and high practicability.

### CROSS-REFERENCE TO RELATED APPLICATIONS

This application is a national stage of International Application No. PCT/CN2023/112861, filed on Aug. 14, 2023, which claims priority to Chinese Patent Application No. 202211674628.0, filed on Dec. 26, 2022, both of which are incorporated herein by reference in their entireties.

### TECHNICAL FIELD

This application relates to the field of antenna technologies, and in particular, to an antenna structure and an electronic device.

### BACKGROUND

Currently, in electronic devices such as a tablet computer and a mobile phone, antennas are usually designed at a border frame position. However, with improvement of integration of an electronic device and progress of an industrial design, a back plate and a border frame of the electronic device may be designed into one piece and both made of metal materials. In this case, a border frame area is covered with metal. Therefore, it is not convenient to arrange the antenna at the border frame position.

### SUMMARY

To resolve the above problem, this application provides an antenna structure and an electronic device. In a scenario where a border frame area of the electronic device is covered with metal, an antenna may still be designed through a camera decoration member area of the electronic device, which has high practicability.

According to a first aspect, this application provides an antenna structure. The antenna structure includes an antenna body and a dielectric layer. The antenna body is attached to the dielectric layer. The antenna body is shaped like a ring. The antenna body includes a feed point, a gap, a first ground point, and a second ground point. The gap is located between the feed point and the second ground point, and the gap extends toward the first ground point. After the gap is formed at the feed point, two sides of the feed point are changed to perform asymmetric feeding. In this case, the antenna structure may excite two different double-wavelength modes, thereby effectively expanding a bandwidth range.

The antenna structure adopts a ring-shaped design, and the asymmetric feeding design is achieved on the two sides of the feed point through the gap. An antenna may be an antenna that supports a plurality of bands, for example, may cover a Wi-Fi 2.4G band and a Wi-Fi 5G band in a plurality of modes, to achieve high efficiency and broadband radiation. In addition, a conformal design may be formed for the antenna and a camera or a flash of the electronic device. The solution has a simple structure, low opinion costs, and relatively high practicality.

In a possible implementation, the antenna structure further includes an elastic feed piece. The elastic feed piece may be elastically connected to a printed circuit board, so that the feed point is connected to a feed source through the elastic feed piece.

In a possible implementation, the antenna structure further includes a first elastic ground piece and a second elastic ground piece. The first elastic ground piece may be elastically connected to a first ground terminal on the printed circuit board, so that the first ground point is connected to the first ground terminal through the first elastic ground piece. The second elastic ground piece may be elastically connected to a second ground terminal on the printed circuit board, so that the second ground point is connected to the second ground terminal through the second elastic ground piece.

In a possible implementation, the antenna structure further includes an inductor. At least one of the first ground point and the second ground point is grounded through the inductor. In other words, the first ground point is grounded through the inductor and the second ground point is directly grounded, or the first ground point is grounded through the inductor and the second ground point is also grounded through the inductor, or the first ground point is directly grounded and the second ground point is grounded through the inductor.

In a possible implementation, the antenna structure further includes a capacitor. At least one of the first ground point and the second ground point is grounded through the capacitor. In other words, the first ground point is grounded through the capacitor and the second ground point is directly grounded, or the first ground point is grounded through the capacitor and the second ground point is also grounded through the capacitor, or the first ground point is directly grounded and the second ground point is grounded through the capacitor.

In a possible implementation, the antenna structure further includes at least one widened portion. A width of each of the at least one widened portion is greater than a width at a non-widened portion of the antenna body.

In a possible implementation, the antenna structure further includes at least one narrowed portion. A width of each of the at least one narrowed portion is less than a width at a non-narrowed portion of the antenna body.

The widened portion or the narrowed portion is arranged to adjust a width of the antenna body at different positions, or may be configured to tune a resonant frequency.

In a possible implementation, the gap extends from an outer diameter of the antenna body toward an inner diameter of the antenna body, and then extends toward the first ground point. A plurality of gaps may alternatively be provided.

The gap may alternatively be replaced with another implementation, for example, a blind groove, a plurality of consecutively arranged through holes, a plurality of consecutively arranged blind holes, and a combination of the above implementations.

In a possible implementation, the antenna body is shaped like a circular ring or a square ring.

According to a second aspect, this application further provides an electronic device. The electronic device may be a mobile phone, a tablet computer, an AR device, a VR device, or the like. The electronic device includes the antenna structure provided in any one of the above implementations, and further includes a camera decoration member. The camera decoration member is configured to cover a camera decoration area of the electronic device. The antenna structure is located in the camera decoration area.

A back plate and a border frame of the electronic device may be designed into one piece and both made of metal materials. In addition, an antenna is designed through the camera decoration member area of the electronic device. The antenna may be an antenna that supports a plurality of bands, for example, may cover a Wi-Fi 2.4G band and a Wi-Fi 5G band in a plurality of modes, to achieve high efficiency and broadband radiation. In addition, a conformal design may be formed for the antenna and a camera or a flash. The solution has a simple structure, low opinion costs, and relatively high practicality.

In a possible implementation, a flash is further arranged in the camera decoration area of the electronic device. The flash is arranged on a ring-shaped inner side of the antenna body. Since the antenna body is shaped like a ring, the flash may be arranged in a center of the ring to save space, forming a conformal design for the ring-shaped antenna and the flash.

In a possible implementation, a camera is further arranged in the camera decoration area of the electronic device. The camera is arranged on the ring-shaped inner side of the antenna body. Since the antenna body is shaped like a ring, the camera may be arranged in a center of the ring to save space, forming a conformal design for the ring-shaped antenna and the camera.

In a possible implementation, the electronic device further includes a printed circuit board. The feed point is connected to a feed source on the printed circuit board. The first ground point is connected to a first ground terminal on the printed circuit board. The second ground point is connected to a second ground terminal on the printed circuit board.

### BRIEF DESCRIPTION OF DRAWINGS

FIG. 1 is a schematic structural diagram of an electronic device;

FIG. 2 is a schematic diagram of a rear cover of an electronic device according to this application;

FIG. 3 is a top view of an antenna structure according to an embodiment of this application;

FIG. 4 is a side view corresponding to FIG. 3 according to an embodiment of this application;

FIG. 5 is a schematic simulation diagram of S11 and an efficiency curve of an antenna according to an embodiment of this application;

FIG. 6 is a schematic diagram of a surface current of Model I according to an embodiment of this application;

FIG. 7 is a schematic diagram of a surface current of Model II according to an embodiment of this application;

FIG. 8 is a schematic diagram of a surface current of Model III according to an embodiment of this application;

FIG. 9 is a far-field directivity diagram of Model II and Model III according to an embodiment of this application;

FIG. 10 is a simulation diagram of a far-field axial ratio of Model II and Model III according to an embodiment of this application;

FIG. 11 is a diagram of a simulation result of matching tuning in Model I according to an embodiment of this application;

FIG. 12 is a diagram of a simulation result of tuning a ground position in Model I according to an embodiment of this application;

FIG. 13 is a schematic diagram of another antenna structure according to an embodiment of this application;

FIG. 14 is a schematic diagram of still another antenna structure according to an embodiment of this application;

FIG. 15 is a schematic simulation diagram I of S11 of an antenna structure according to an embodiment of this application;

FIG. 16 is a schematic diagram of yet another antenna structure according to an embodiment of this application;

FIG. 17 is a schematic diagram of another antenna structure according to an embodiment of this application;

FIG. 18 is a schematic simulation diagram II of S11 of an antenna structure according to an embodiment of this application;

FIG. 19 is a schematic diagram of an implementation of an antenna structure in an electronic device according to an embodiment of this application;

FIG. 20 is a side view corresponding to FIG. 19 according to an embodiment of this application; and

FIG. 21 is a schematic diagram of an electronic device according to an embodiment of this application.

### DESCRIPTION OF EMBODIMENTS

In the specification, claims, and accompanying drawings of this application, terms “first”, “second”, “third”, and the like are intended to distinguish between different objects but do not define a particular order.

To enable a person skilled in the art to understand the solution of this application more clearly, an application scenario of the technical solution of this application is described below first.

A type of an electronic device is not specifically limited in this application. The electronic device may be a mobile phone, a tablet computer, an augmented reality (AR) device, a virtual reality (VR) device, or the like. A description is provided below by using an example in which the electronic device is a mobile phone or a tablet computer.

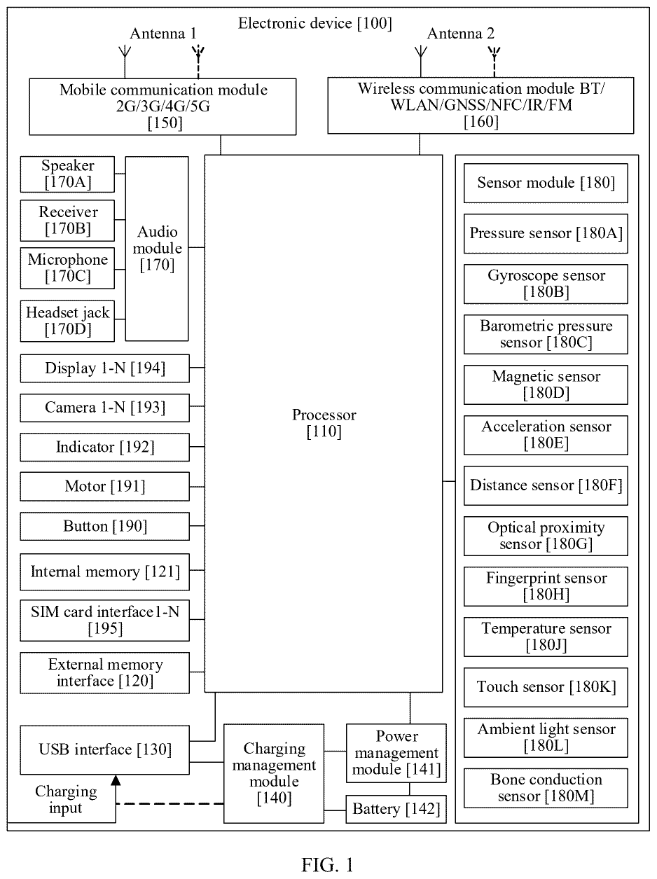

Referring to FIG. 1, FIG. 1 is a schematic structural diagram of an electronic device.

An electronic device 100 may include a processor 110, an external memory interface 120, an internal memory 121, a universal serial bus (USB) interface 130, a charging management module 140, a power management unit 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like.

The sensor module 180 may include one or more of a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that an example structure in this embodiment of the present invention does not constitute a specific limitation on the electronic device 100. In some other embodiments of this application, the electronic device 100 may include more or fewer components than those shown in the figure, or some merged components, or some split components, or different component arrangements. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, and/or a neural network processing unit (NPU). Different processing units may be independent devices, or may be integrated into one or more processors.

The controller may generate an operation control signal based on instruction operation code and a time-sequence signal, and control obtaining and executing of instructions.

A memory may be further arranged in the processor 110, which is configured to store instructions and data. In some embodiments, the memory in the processor 110 is a cache memory. The memory may store instructions or data that is recently used or cyclically used by the processor 110. If the processor 110 needs to use the instructions or the data again, the processor may directly invoke the instructions or the data from the memory. Repeated access is avoided, and waiting time of the processor 110 is reduced, thereby improving system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The charging management module 140 is configured to receive a charging input from a charger. The charger may be a wireless charger, or may be a wired charger. In some embodiments of wired charging, the charging management module 140 may receive a charging input of a wired charger through the USB interface 130. In some embodiments of wireless charging, the charging management module 140 may receive a wireless charging input through a wireless charging coil of the electronic device 100. The charging management module 140 may further supply power to the electronic device through the power management module 141 while charging the battery 142.

The power management module 141 is configured to connect to the battery 142, the charging management module 140, and the processor 110. The power management module 141 receives an input of the battery 142 and/or the charging management module 140, to supply power to the processor 110, the internal memory 121, the display 194, the camera 193, the wireless communication module 160, and the like. The power management module 141 may further be configured to monitor parameters such as a battery capacity, a quantity of battery cycles, and a battery health state (power leakage and impedance). In some other embodiments, the power management module 141 may alternatively be arranged in the processor 110. In some other embodiments, the power management module 141 and the charging management module 140 may also be arranged in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication bands. Different antennas may be further multiplexed to increase a utilization rate of the antennas. For example, the antenna 1 may be multiplexed into a diversity antenna of a wireless local area network. In some other embodiments, the antenna may be used in combination with a tuning switch.

The mobile communication module 150 may provide a solution to wireless communication including 2G/3G/4G/5G and the like applied to the electronic device 100. The mobile communication module 150 may include at least one filter, a switch, a power amplifier, a low noise amplifier (LNA), and the like. The mobile communication module 150 may receive an electromagnetic wave through the antenna 1, perform processing such as filtering and amplification on the received electromagnetic wave, and transmit the processed electromagnetic wave to the modem processor for demodulation. The mobile communication module 150 may further amplify a signal modulated by the modem processor, and convert the signal into an electromagnetic wave through the antenna 1 for radiation. In some embodiments, at least some functional modules of the mobile communication module 150 may be arranged in the processor 110. In some embodiments, at least some of the functional modules of the mobile communication module 150 may be arranged in a same device as at least some of the modules of the processor 110 The modem processor may include a modulator and a demodulator. The modulator is configured to modulate a to-be-sent low-frequency baseband signal into a medium or high-frequency signal. The demodulator is configured to demodulate a received electromagnetic wave signal into a low-frequency baseband signal. Then the demodulator transmits the low-frequency baseband signal obtained through demodulation to the baseband processor for processing. The low-frequency baseband signal is processed by the baseband processor and then transmitted to an application processor. The application processor outputs a sound signal through an audio device (which is not limited to the speaker 170A, the receiver 170B, and the like), or displays an image or a video through the display 194. In some embodiments, the modem processor may be an independent device. In some other embodiments, the modem processor may be independent of the processor 110, and is arranged in a same device as the mobile communication module 150 or another functional module.

The wireless communication module 160 may provide a solution to wireless communication including a wireless local area network (WLAN) (for example, a wireless fidelity (Wi-Fi) network), bluetooth (BT), a global navigation satellite system (GNSS), frequency modulation (FM), near field communication (NFC), an infrared (IR) technology, and the like applied to the electronic device 100. The wireless communication module 160 may be one or more devices into which at least one communication processing module is integrated. The wireless communications module 160 receives an electromagnetic wave through the antenna 2, performs frequency modulation and filtering on the electromagnetic wave signal, and sends the processed signal to the processor 110. The wireless communication module 160 may further receive a to-be-sent signal from the processor 110, perform frequency modulation and amplification on the to-be-sent signal, and convert the to-be-sent signal into an electromagnetic wave through the antenna 2 for radiation.

In some embodiments, in the electronic device 100, the antenna 1 is coupled to the mobile communication module 150, and the antenna 2 is coupled to the wireless communication module 160, so that the electronic device 100 may communicate with a network and another device through a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a Beidou navigation satellite system (BDS), a quasi-zenith satellite system (QZSS), and/or a satellite-based augmentation system (SBAS).

The electronic device 100 implements a display function through the GPU, the display 194, the application processor, and the like. The GPU is a microprocessor for image processing, and is connected to the display 194 and the application processor. The GPU is configured to perform mathematical and geometric calculation, and is configured to perform graphics rendering. The processor 110 may include one or more GPUs, and is configured to execute program instructions to generate or change display information.

The display 194 is configured to display an image, a video, or the like. The display 194 includes a display panel. The display panel may use a liquid crystal display (LCD), an organic light-emitting diode (OLED), an active-matrix organic light emitting diode (AMOLED), a flexible light-emitting diode (FLED), a MiniLED, a MicroLED, a Micro-OLED, a quantum dot light emitting diode (QLED), and the like. In some embodiments, the electronic device 100 may include 1 or N displays 194. N is a positive integer greater than 1.

The electronic device 100 may implement a photographing function through the image signal processor (ISP), the camera 193, the video codec, the GPU, the display 194, the application processor, and the like.

The ISP is configured to process data fed back by the camera 193. For example, during photographing, a shutter is enabled. Light is transmitted to a photosensitive element of the camera through a lens, and an optical signal is converted into an electrical signal. The photosensitive element of the camera transmits the electrical signal to the ISP for processing, and the electrical signal is converted into an image visible to a naked eye. The ISP may further perform algorithm optimization on a noise point, brightness, and a skin tone of the image. The ISP may further optimize parameters such as exposure and a color temperature of a to-be-photographed scene. In some embodiments, the ISP may be arranged in the camera 193.

The camera 193 is configured to capture a still image or a video. An optical image is generated for an object through the lens and is projected onto a photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP, to convert the electrical signal into a digital image signal. The ISP outputs the digital image signal to the DSP for processing. The DSP converts the digital image signal into an image signal in a standard format such as RGB or YUV. In some embodiments, the electronic device 100 may include 1 or N cameras 193, Nis a positive integer greater than 1.

The digital signal processor is configured to process a digital signal. In addition to a digital image signal, the digital signal processor may further process another digital signal. For example, when the electronic device 100 performs frequency selection, the digital signal processor is configured to perform Fourier transform and the like on frequency energy.

The video codec is configured to compress or decompress a digital video. The electronic device 100 may support one or more video codecs. In this way, the electronic device 100 may play or record videos in a plurality of encoding formats, for example, moving picture experts group (MPEG) 1, MPEG 2, MPEG 3, and MPEG 4.

The NPU is a neural network (NN) computing processor, which quickly processes input information by learning from a structure of a biological neural network, for example, a mode of transmission between neurons in a human brain, and may further continuously perform self-learning. The NPU may be configured to implement an application such as intelligent cognition of the electronic device 100, for example, image recognition, face recognition, voice recognition, and text understanding.

The external memory interface 120 may be configured to connect to an external storage card such as a micro SD card, to expand a storage capacity of the electronic device 100. The external storage card communicates with the processor 110 through the external memory interface 120, to implement a data storage function. For example, files such as music and a video are stored into the external storage card.

The internal memory 121 may be configured to store computer-executable program code. The executable program code includes instructions. The internal memory 121 may include a program storage area and a data storage area. The program storage area may store an operating system, an application required by at least one function (for example, a sound playback function or an image playback function), and the like. The data storage area may store data (for example, audio data and an address book) and the like created during use of the electronic device 100. In addition, the internal memory 121 may include a high-speed random access memory, and may further include a non-volatile memory, for example, at least one magnetic disk storage device, a flash memory device, or a universal flash storage (UFS). The processor 110 runs the instructions stored in the internal memory 121, and/or the instructions stored in the memory arranged in the processor, to perform various function applications and data processing of the electronic device 100.

The electronic device 100 may implement an audio function such as music playback or recording through the audio module 170, the speaker 170A, the receiver 170B, the microphone 170C, the headset jack 170D, the application processor, and the like.

The audio module 170 is configured to convert digital audio information into an analog audio signal output, and is also configured to convert an analog audio input into a digital audio signal. The audio module 170 may be further configured to encode and decode an audio signal. In some embodiments, the audio module 170 may be arranged in the processor 110, or some functional modules in the audio module 170 are arranged in the processor 110.

The speaker 170A, also referred to as a “horn”, is configured to convert an electrical audio signal into a sound signal. Music may be listened to or a hands-free call may be answered through the speaker 170A in the electronic device 100.

The receiver 170B, also referred to as a “handset”, is configured to convert an electrical audio signal into a sound signal. When the electronic device 100 is configured to answer a call or receive voice information, the receiver 170B may be put close to a human ear to receive a voice.

The microphone 170C, also referred to as a “voice tube” or “mike”, is configured to convert a sound signal into an electrical signal. When making a call or sending voice information, a user may make a sound approaching the microphone 170C through a mouth of the user, to input a sound signal into the microphone 170C. At least one microphone 170C may be arranged in the electronic device 100. In some other embodiments, two microphones 170C may be arranged in the electronic device 100, to collect a sound signal and implement a noise reduction function. In some other embodiments, three, four, or more microphones 170C may be alternatively arranged in the electronic device 100, to collect a sound signal, implement noise reduction, recognize a sound source, implement a directional recording function, and the like.

Currently, in electronic devices such as a tablet computer and a mobile phone, antennas are usually designed at a border frame position. However, with improvement of integration of an electronic device and progress of an industrial design, a back plate and a border frame of the electronic device may be designed into one piece and both made of metal materials. In this case, a border frame area is covered with metal. Therefore, it is not convenient to arrange the antenna at the border frame position.

To resolve the above problem, this application provides an antenna structure and an electronic device. An antenna is designed through a camera decoration member area of the electronic device. The antenna may be an antenna that supports a plurality of bands. In addition, a conformal design may be formed for the antenna and a camera or a flash. The solution has a simple structure, low opinion costs, and relatively high practicality.

To enable a person skilled in the art to understand the solution of this application more clearly, technical solutions in embodiments of this application are described below with reference to the accompanying drawings in embodiments of this application.

Terms “first”, “second”, and the like in the description of this application are merely used for a purpose of description, and cannot be understood as indicating or implying relative significance or implicitly indicating a quantity of indicated technical features.

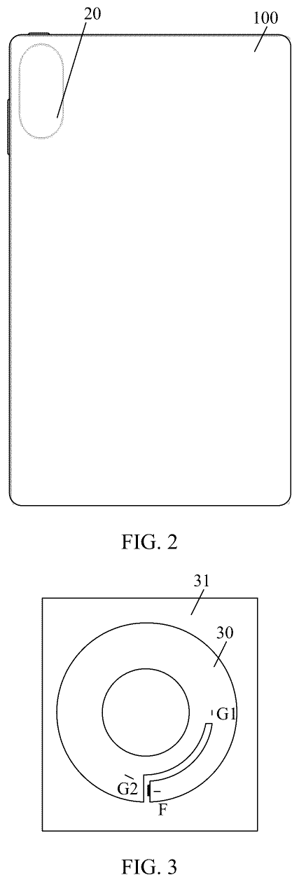

Referring to FIG. 2, FIG. 2 is a schematic diagram of a rear cover of an electronic device according to this application.

For an integrally designed electronic device having a rear cover made of a metal material, only a camera decoration member (deco) area 20 behind a screen may be not covered by metal. In other words, the area may be used for an antenna layout.

A description is provided below with reference to specific implementations.

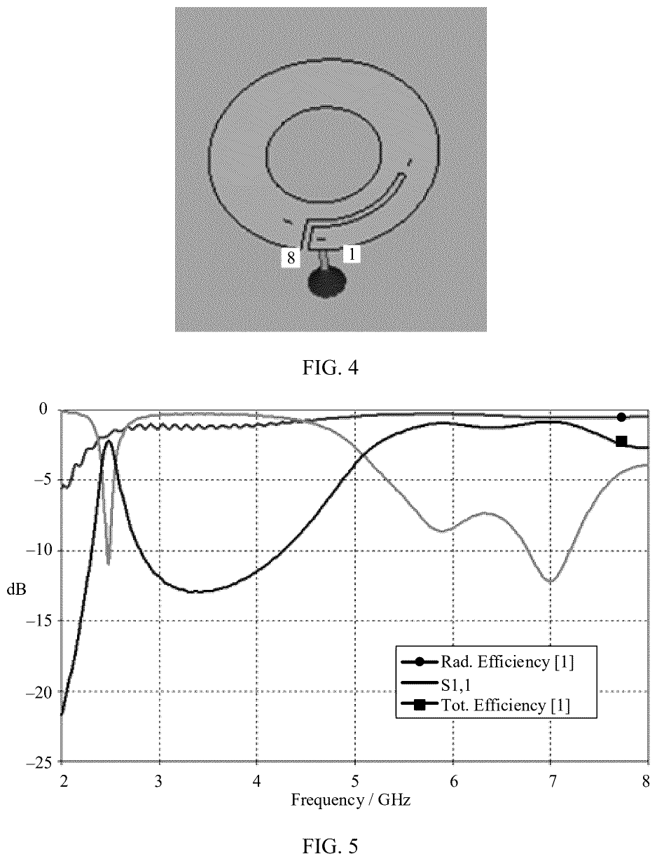

Refer to FIG. 3 and FIG. 4 together. FIG. 3 is a top view of an antenna structure according to an embodiment of this application. FIG. 4 is a side view corresponding to FIG. 3 according to an embodiment of this application.

The antenna structure includes an antenna body 30 and a dielectric layer 31.

The antenna body 30 includes a feed point F and two ground points. The two ground points are respectively a first ground point G1 and a second ground point G2.

The first ground point G1 and the second ground point G2 may be directly grounded, or grounded through a capacitor, or grounded through an inductor. This is not specifically limited in this embodiment of this application. The grounding manners of the first ground point G1 and the second ground point G2 may be the same or different. For example, the first ground point G1 is grounded through the capacitor, and the second ground point G2 is grounded through the inductor.

A gap exists at the feed point F. The gap in FIG. 3 is a through slot.

The antenna body 30 is attached to a surface of the dielectric layer 31. The dielectric layer 31 may be located on an upper layer of the antenna body 30 or on a lower layer of the antenna body 30. This is not specifically limited in this embodiment of this application.

The dielectric layer 31 is connected to a metal floor. The metal floor may be a printed circuit board (PCB), a metal middle frame, or a metal iron frame of an electronic device.

Referring to FIG. 5, FIG. 5 is a schematic simulation diagram of S11 and an efficiency curve of an antenna according to an embodiment of this application.

It may be learned from the curve S11 in FIG. 5 that the antenna structure excites three modes in total, which are respectively described below.

Mode I: In this mode, the antenna is mainly configured to cover a Wi-Fi 2.4G band used by existing electronic devices, that is, cover a frequency range of 2.415-2.485 GHz.

Mode II and Mode III: In this mode, the antenna may be configured to cover a Wi-Fi 5G band (in a frequency range of 5.15-5.85 GHz). In addition, in Mode II and Mode III, the antenna may be further configured to cover a Wi-Fi 6E band (in a frequency range of 5.925-7.125 GHZ).

In the three modes, antenna efficiency is relatively high. Mode II and Mode III may be further combined to form broadband radiation.

An operating principle of the antenna structure is described below.

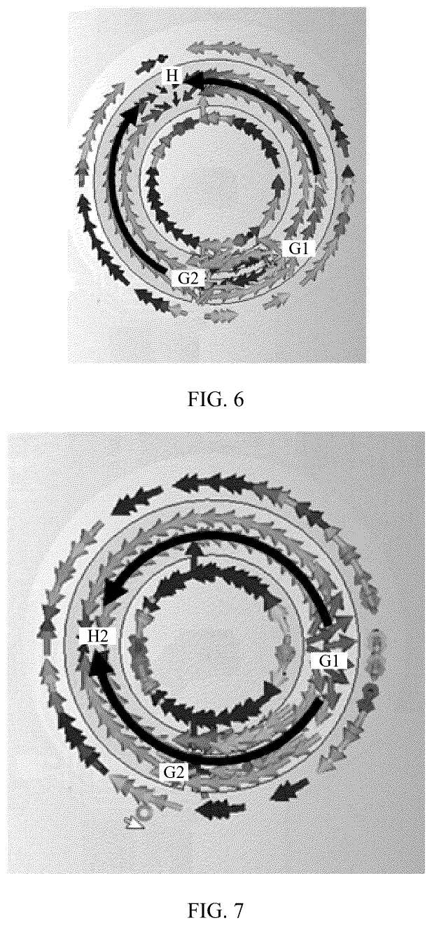

Referring to FIG. 6, FIG. 6 is a schematic diagram of a surface current of Model I according to an embodiment of this application.

It may be learned based on a current distribution in FIG. 6 that Mode I is a half-wavelength mode of a large arc between a first ground point G1 and a second ground point G2. In other words, a current flows counterclockwise from the first ground point G1 to a point H1 along the arc, and another current flows clockwise from the second ground point G2 to the point H1 along the arc.

Assuming that a lowermost point of the antenna body 30 is defined as 0 degrees and one counterclockwise rotation covers 0-360°, a range of the arc of Mode I is about 90-360°.

Referring to FIG. 7, FIG. 7 is a schematic diagram of a surface current of Model II according to an embodiment of this application.

It may be learned based on a current distribution in FIG. 7 that Mode II is a double wavelength mode of an entire circular ring.

In other words, a current flows counterclockwise from the first ground point G1 to a point H2 along an arc, and another current flows clockwise from the first ground point G1 to a point H1 along the arc.

A range of the arc of Mode II is about 0°-360°.

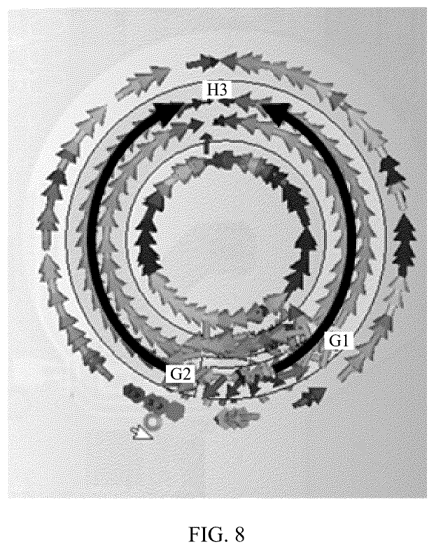

Referring to FIG. 8, FIG. 8 is a schematic diagram of a surface current of Model III according to an embodiment of this application.

It may be learned based on a current distribution in FIG. 8 that Mode III is also a double wavelength mode of an entire circular ring.

In other words, a current flows counterclockwise from a second ground point G2 to a point H3 along an arc, and another current flows clockwise from the second ground point G2 to the point H3 along the arc.

A range of the arc of Mode III is about 0°-360°.

Although Mode II and Mode III are both the double wavelength modes of the entire circular ring, current directions are perpendicular to each other and are a pair of degenerate modes.

In this embodiment of this application, a function of forming the gap at the feed point F is as follows. If no gap is formed, structures of two ends of the feed point are symmetrical, and only one of the pair of degenerate modes, that is, Mode II and Mode III, can be excited, resulting in a narrow bandwidth. However, after the gap is formed at the feed point F, referring to FIG. 7 and FIG. 8 together, the two sides of the feed point F are changed to perform asymmetric feeding, and Mode II and Mode III can be excited simultaneously, which can effectively expand a bandwidth range.

In this embodiment of this application, an extending direction of the gap is an example of extending from an outer diameter of the antenna body toward an inner diameter of the antenna body, and then extending counterclockwise along the circular ring, that is, extending from the feed point toward the first ground point. A specific width, a length extending radially, and a length extending counterclockwise along the circular ring of the gap are not specifically limited in this embodiment of this application.

In some other embodiments, a plurality of gaps may alternatively be provided.

In an actual application, the gap may alternatively be replaced with another implementation, for example, a blind groove, a plurality of consecutively arranged through holes, a plurality of consecutively arranged blind holes, and a combination of the above implementations, as long as the two sides of the feed point F can be changed to perform asymmetric feeding.

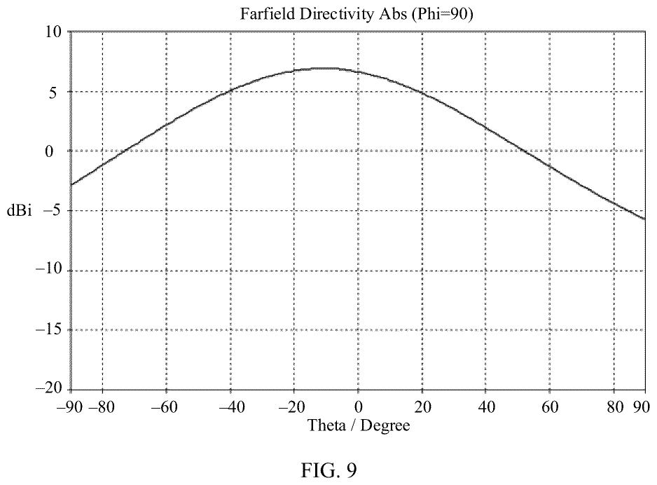

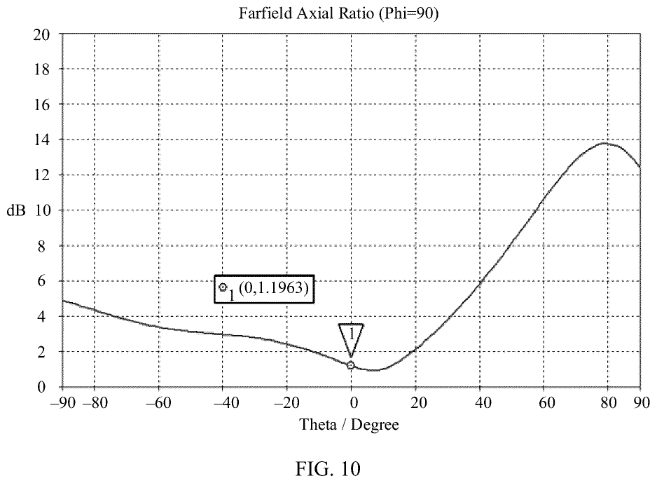

Refer to FIG. 9 and FIG. 10 together. FIG. 9 is a far-field directivity diagram of Model II and Model III according to an embodiment of this application. FIG. 10 is a simulation diagram of a far-field axial ratio of Model II and Model III according to an embodiment of this application.

It may be learned that within a main lobe range, the axial ratio is significantly small, which indicates that a circular polarization characteristic is relatively desirable, and a circularly polarized wave is radiated. This is because Mode II and Mode III are a pair of degenerate orthogonal modes. When the two modes are excited, the two modes may be combined to form a circularly polarized wave.

In some embodiments, still referring to FIG. 6, since Mode I in this embodiment of this application is the half-wavelength mode formed between the first ground point G1 and the second ground point G2, after the ground point is grounded through a capacitor or an inductor, tuning of a frequency covered by Mode I can be achieved. A description is provided below in combination with a simulation result.

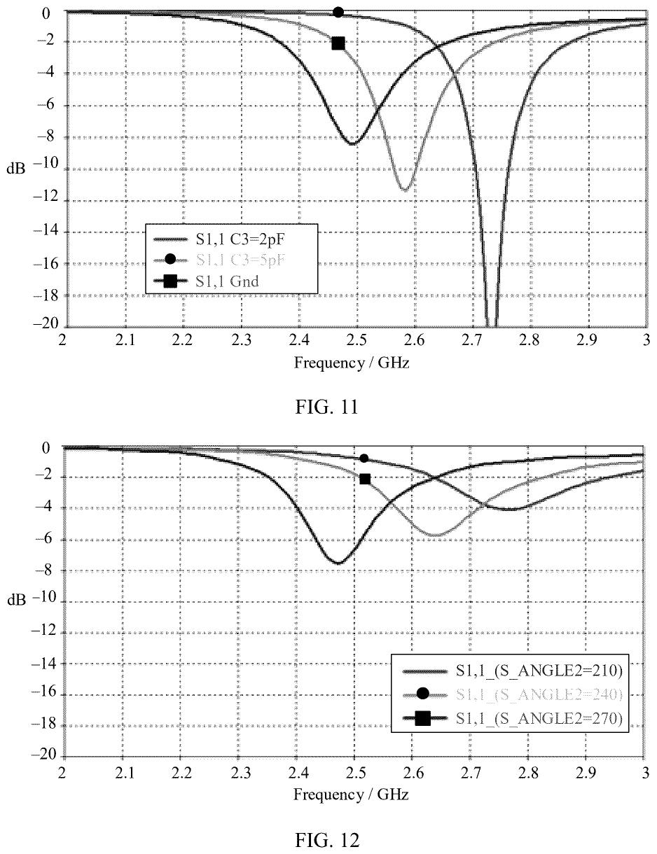

Referring to FIG. 11, FIG. 11 is a diagram of a simulation result of matching tuning in Model I according to an embodiment of this application.

When a ground point is directly grounded, a resonant frequency of Mode I is about 2.48 GHz.

When the ground point is grounded by using a capacitor of 2 pF, the resonant frequency of Mode I is about 2.73 GHZ.

When the ground point is grounded by using a capacitor of 5 pF, the resonant frequency of Mode I is about 2.58 GHZ.

It may be found that adjusting the capacitor of the ground point may effectively achieve tuning of a frequency covered by Mode I. Therefore, in an actual application, a reasonable capacitor or inductor device may be selected based on an actual frequency requirement.

The above merely illustrates the simulation result of achieving the frequency tuning by using the capacitor. In an actual application, the frequency tuning may also be achieved by using an inductor. Details are not described in this embodiment of this application.

Components such as a capacitor and an inductor are generally arranged on a circuit board. During grounding, a ground point of an antenna structure is grounded through the capacitor or the inductor on the circuit board. During application of the inductor, at least one of a first ground point and a second ground point is grounded through the inductor. For example, the first ground point is grounded through the inductor and the second ground point is directly grounded, or the first ground point is grounded through the inductor and the second ground point is also grounded through the inductor, or the first ground point is directly grounded and the second ground point is grounded through the inductor. During application of the capacitor, at least one of the first ground point and the second ground point is grounded through the capacitor. For example, the first ground point is grounded through the capacitor and the second ground point is directly grounded, or the first ground point is grounded through the capacitor and the second ground point is also grounded through the capacitor, or the first ground point is directly grounded and the second ground point is grounded through the capacitor.

In some other embodiments, still referring to FIG. 6, since Mode I in this embodiment of this application is the half-wavelength mode formed between the first ground point G1 and the second ground point G2, a frequency covered by Mode I may also be tuned by changing a distance between the two ground points. A description is provided below in combination with a simulation result.

Referring to FIG. 12, FIG. 12 is a diagram of a simulation result of tuning of a ground position in Model I according to an embodiment of this application.

When an included angle between a first ground point G1 and a second ground point G2 in a counterclockwise direction along a circular ring is 210°, a resonant frequency of Mode I is about 2.75 GHZ.

When the included angle between the first ground point G1 and the second ground point G2 in the counterclockwise direction along the circular ring is 240°, the resonant frequency of Mode I is about 2.64 GHZ.

When the included angle between the first ground point Gl and the second ground point G2 in the counterclockwise direction along the circular ring is 270°, the resonant frequency of Mode I is about 2.48 GHZ.

It may be found that adjusting a distance between the two ground points may effectively achieve tuning of a frequency covered by Mode I.

In addition, in still other embodiments, a width of an antenna body 30 at different positions may also be adjusted to tune a resonant frequency. A detailed description is provided below in combination with a simulation result.

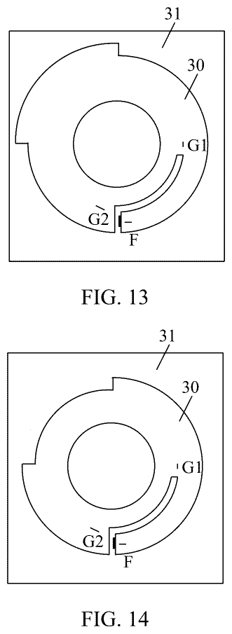

Refer to FIG. 13 and FIG. 14 together. FIG. 13 is a schematic diagram of another antenna structure according to an embodiment of this application. FIG. 14 is a schematic diagram of still another antenna structure according to an embodiment of this application.

A difference between the antenna structure in FIG. 13 and the antenna structure in FIG. 3 is that an antenna width of the antenna structure in FIG. 13 is increased by 1 millimeter at a position in a range of 180°-270°.

A difference between the antenna structure in FIG. 14 and the antenna structure in FIG. 3 is that an antenna width of the antenna structure in FIG. 14 is reduced by 1 millimeter at a position in a range of 180°-270°.

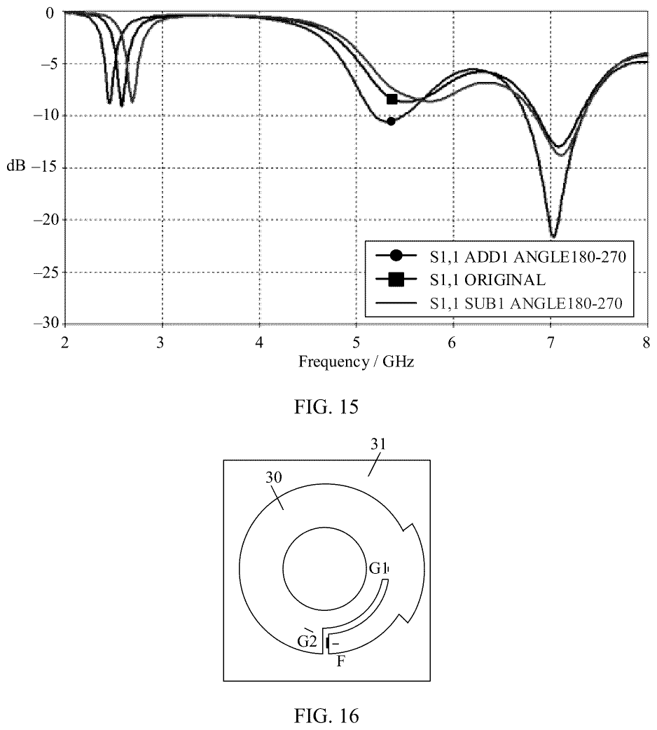

Referring to FIG. 15, FIG. 15 is a schematic simulation diagram I of S11 of an antenna structure according to an embodiment of this application.

It may be learned based on a curve S1,1 ORIGINAL that when an antenna width is not increased or reduced, a band range of Mode I is about 2.415-2.485 GHZ.

It may be learned based on a curve S1,1 270 that when an antenna width at a position in a range of 180°-270° is increased, the band range of Mode I is reduced.

It may be learned based on a curve S1,1 SUB1 ANGLE180-270 that when the antenna width at the position in a range of 180°-270° is reduced, the band range of Mode I is increased.

A change of the antenna width at the position in a range of 180°-270° has relatively little impact on frequencies of Mode II and Mode III.

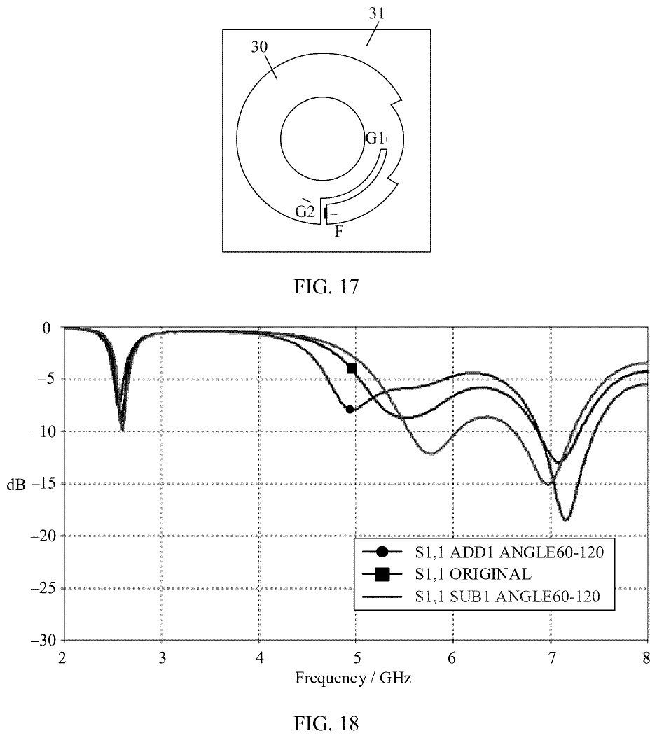

Refer to FIG. 16 and FIG. 17 together. FIG. 16 is a schematic diagram of yet another antenna structure according to an embodiment of this application. FIG. 17 is a schematic diagram of another antenna structure according to an embodiment of this application.

A difference between the antenna structure in FIG. 16 and the antenna structure in FIG. 3 is that an antenna width of the antenna structure in FIG. 16 is increased by 1 millimeter at a position in a range of 60°-120°.

A difference between the antenna structure in FIG. 17 and the antenna structure in FIG. 3 is that an antenna width of the antenna structure in FIG. 17 is reduced by 1 millimeter at a position in a range of 60°-120°.

Referring to FIG. 18, FIG. 18 is a schematic simulation diagram II of S11 of an antenna structure according to an embodiment of this application.

It may be learned based on a curve S1, 1 ORIGINAL that when an antenna width is not increased or reduced, a band range of Mode I is about 2.415-2.485 GHz. Mode II and Mode III may cover a range of 5.15-5.85 GHz and a range of 5.925-7.125 GHz.

It may be learned based on a curve S1,1 ADD1 ANGLE 60-120 that an increase in an antenna width at a position in a range of 60°-120° has relatively little impact on the band range of Mode I, and band ranges of Mode II and Mode III are reduced.

It may be learned based on a curve S1,1 SUB1 ANGLE 60-120 that a reduction in the antenna width at the position in a range of 60°-120° has relatively little impact on the band range of Mode I, and the band ranges of Mode II and Mode III are increased.

One or more positions of a circular ring may be narrowed or widened, or an antenna body may include one or more narrowed portions and/or one or more widened portions, so as to tune a band to a target band. A width of the narrowed portion is less than a width at a non-narrowed portion of the antenna body. A width of the widened portion is greater than a width at a non-widened portion of the antenna body.

An implementation of the antenna structure is described below in combination with an application scenario.

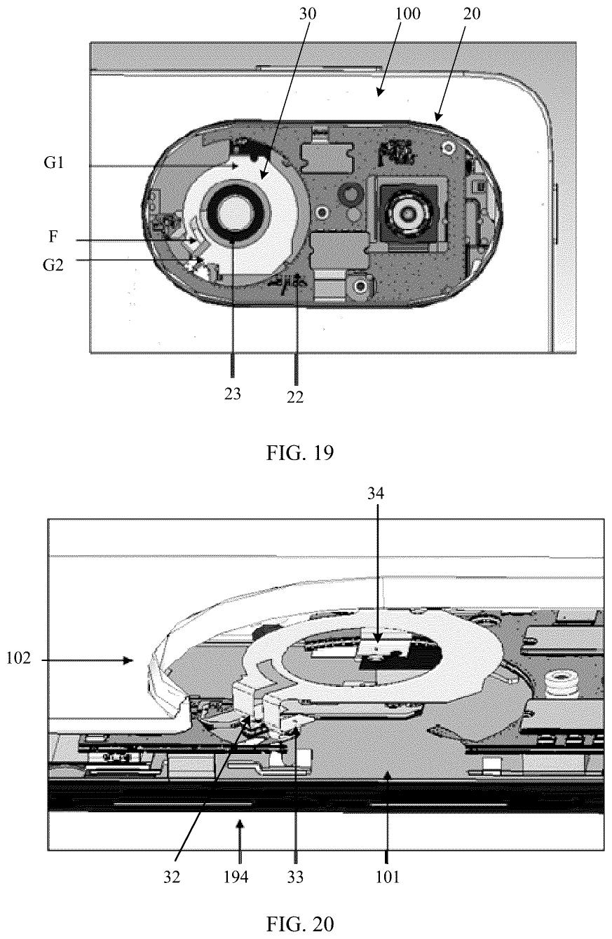

Refer to FIG. 19 and FIG. 20 together. FIG. 19 is a schematic diagram of an implementation of an antenna structure in an electronic device according to an embodiment of this application. FIG. 20 is a side view corresponding to FIG. 19 according to an embodiment of this application.

The antenna structure is arranged in a camera decoration member area 20 of an electronic device 100.

The camera decoration member area 20 is used for a camera module of the electronic device 100 to be arranged, which specifically includes a flash and one or more cameras.

An antenna body 30 of the antenna structure may be attached to a plastic support (not shown in the figure) to achieve fixation. Since the antenna body 30 is shaped like a circular ring, a flash 23 may be arranged in a center of a circle of the circular ring to save space, forming a conformal design for the ring-shaped antenna and the flash.

Referring to FIG. 20, a feed point F and two ground points of an antenna may be connected to a PCB 101 through an elastic piece.

Specifically, the feed point F is connected to a feed source on the PCB through an elastic feed piece.

A first ground point G1 is connected to a first ground terminal on the PCB 101 through a first elastic ground piece 34, and a second ground point G2 is connected to a second ground terminal on the PCB 101 through a second elastic ground piece 33.

A floor of the antenna structure may be a metal iron frame of the PCB 101 and a screen 194.

The above description is provided by using an example in which the flash of the electronic device is arranged at a center of a circle of the circular ring of the antenna body. In an actual application, the camera of the electronic device may alternatively be arranged at the center of a circle of the circular ring of the antenna body. Details are not described herein.

It may be understood that, in the above embodiments of this application, the description is provided by using an example in which the antenna body is shaped like the circular ring. In an actual application, the antenna body may be shaped like another ring, for example, a square ring.

Based on the above, in the antenna structure provided in embodiments of this application, an antenna is designed through the camera decoration member area of the electronic device. The antenna may be an antenna that supports a plurality of bands, for example, may cover a Wi-Fi 2.4G band and a Wi-Fi 5G band in a plurality of modes, to achieve high efficiency and broadband radiation. In addition, a conformal design may be formed for the antenna and a camera or a flash. The solution has a simple structure, low opinion costs, and relatively high practicality.

Based on the antenna structure provided in the above embodiments, an embodiment of this application further provides an electronic device. A detailed description is provided below with reference to the accompanying drawings.

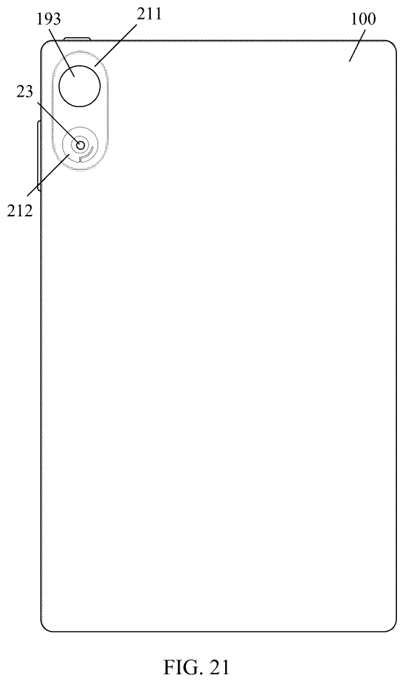

Referring to FIG. 21, FIG. 21 is a schematic diagram of an electronic device according to an embodiment of this application.

An electronic device 100 includes a camera decoration member 211 and an antenna structure 212.

A camera decoration member area where the camera decoration member 211 is located is configured for a camera 193 and a flash 23 of the electronic device to be arranged. The camera decoration member 211 covers the camera decoration member area, and is located outside the camera 193, the flash 23, and the antenna structure 212, thereby providing structural support and air tightness protection.

The flash 23 may be arranged in a center of a circle of a circular ring of the antenna structure 212 to save space, forming a conformal design for the ring-shaped antenna and the flash.

For a specific implementation and an operating principle of the antenna structure 212, reference may be made to the relevant description in the above embodiments. Details are not described again in embodiments of this application.

Based on the above, in the electronic device provided in this embodiment of this application, a back plate and a border frame may be designed into one piece and both made of metal materials. In addition, an antenna is designed through the camera decoration member area of the electronic device. The antenna may be an antenna that supports a plurality of bands, for example, may cover a Wi-Fi 2.4G band and a Wi-Fi 5G band in a plurality of modes, to achieve high efficiency and broadband radiation. In addition, a conformal design may be formed for the antenna and a camera or a flash. The solution has a simple structure, low opinion costs, and relatively high practicality.

The electronic device may be a mobile phone, a tablet computer, an AR device, a VR device, or the like. This is not specifically limited in this embodiment of this application.

It should be understood that, in this application, “at least one (item)” means one or more, and “a plurality of” means two or more. The term “and/or” is used for describing an association relationship between associated objects and representing that three relationships may exist. For example, “A and/or B” may represent the following three cases: only A exists, only B exists, and both A and B exist, where A and B may be singular or plural. The character “/” generally indicates an “or” relationship between a preceding associated object and a succeeding associated object. “At least one of the following items (pieces)” or a similar expression thereof refers to any combination of these items, including a single item (piece) or any combination of a plurality of items (pieces). For example, at least one of a, b, or c may represent a, b, c, “a and b”, “a and c”, “b and c”, or “a, b, and c”, where a, b, and c may be singular or plural.

Based on the above, the foregoing embodiments are merely intended to describe the technical solutions of this application, and are not intended to limit this application. Although this application is described in detail with reference to the above embodiments, a person of ordinary skill in the art should understand that modifications may still be made to the technical solutions described in the above embodiments, or equivalent substitutions may be made to some of the technical features. However, these modifications or substitutions do not make the essence of the corresponding technical solutions depart from the spirit and scope of the technical solutions in embodiments of this application.

1. An antenna structure, comprising an antenna body and a dielectric layer, wherein
the antenna body is attached to the dielectric layer;
the antenna body is shaped like a ring, and comprises a feed point, a gap, a first ground point, and a second ground point; and
the gap is located between the feed point and the second ground point, and the gap extends toward the first ground point.

2. The antenna structure according to claim 1, further comprising an elastic feed piece, wherein
the feed point is connected to a feed source through the elastic feed piece.

3. The antenna structure according to claim 1, further comprising a first elastic ground piece and a second elastic ground piece, wherein
the first ground point is connected to a first ground terminal through the first elastic ground piece; and
the second ground point is connected to a second ground terminal through the second elastic ground piece.

4. The antenna structure according to claim 1, further comprising an inductor, wherein at least one of the first ground point and the second ground point is grounded through the inductor.

5. The antenna structure according to claim 1, further comprising a capacitor, wherein at least one of the first ground point and the second ground point is grounded through the capacitor.

6. The antenna structure according to claim 1, further comprising at least one widened portion, wherein a width of each of the at least one widened portion is greater than a width at a non-widened portion of the antenna body.

7. The antenna structure according to claim 1, further comprising at least one narrowed portion, wherein a width of each of the at least one narrowed portion is less than a width at a non-narrowed portion of the antenna body.

8. The antenna structure according to claim 1, wherein the gap extends from an outer diameter of the antenna body toward an inner diameter of the antenna body, and then extends toward the first ground point.

9. The antenna structure according to claim 1, wherein the antenna body is shaped like a circular ring or a square ring.

10. The antenna structure according to claim 1, wherein an operating band of the antenna structure is configured to cover a Wi-Fi 2.4 GHz band and a Wi-Fi 5 GHz band.

11. An electronic device, comprising
a camera decoration member configured to cover a camera decoration area of the electronic device; and
an antenna structure located in the camera decoration area, wherein the antenna structure comprises an antenna body and a dielectric layer, wherein
the antenna body is attached to the dielectric layer,
the antenna body is shaped like a ring, and comprises a feed point, a gap, a first ground point, and a second ground point, and
the gap is located between the feed point and the second ground point, and the gap extends toward the first ground point.

12. The electronic device according to claim 11, wherein a flash is further arranged in the camera decoration area of the electronic device; and
the flash is arranged on a ring-shaped inner side of the antenna body.

13. The electronic device according to claim 11, wherein a camera is further arranged in the camera decoration area of the electronic device; and
the camera is arranged on a ring-shaped inner side of the antenna body.

14. The electronic device according to claim 11, further comprising a printed circuit board, wherein the feed point is connected to a feed source on the printed circuit board;
the first ground point is connected to a first ground terminal on the printed circuit board; and
the second ground point is connected to a second ground terminal on the printed circuit board.

15. The electronic device according to claim 11, wherein the antenna structure further comprises an elastic feed piece, wherein the feed point is connected to a feed source through the elastic feed piece.

16. The electronic device according to claim 11, wherein the antenna structure further comprises a first elastic ground piece and a second elastic ground piece, wherein
the first ground point is connected to a first ground terminal through the first elastic ground piece; and
the second ground point is connected to a second ground terminal through the second elastic ground piece.

17. The electronic device according to claim 11, wherein the antenna structure further comprises an inductor, wherein at least one of the first ground point and the second ground point is grounded through the inductor.

18. The electronic device according to claim 11, wherein the antenna structure further comprises a capacitor, wherein at least one of the first ground point and the second ground point is grounded through the capacitor.

19. The electronic device according to claim 11, wherein the antenna structure further comprises at least one widened portion, wherein a width of each of the at least one widened portion is greater than a width at a non-widened portion of the antenna body.

20. The electronic device according to claim 11, wherein the antenna structure further comprises at least one narrowed portion, wherein a width of each of the at least one narrowed portion is less than a width at a non-narrowed portion of the antenna body.
